(19) United States
(12) Patent Application Publication
(10) Pub. No.: US 2020/0375094 A1
(43) Pub. Date: Dec. 3, 2020

(54) AUTONOMOUS CROP MANAGEMENT SYSTEM

(71) Applicant: The University of Sydney, New South Wales (AU)

(72) Inventors: Mark Calleija, New South Wales (AU); Salah Sukkarieh, New South Wales (AU)

(21) Appl. No.: 16/766,370

(22) PCT Filed: Nov. 23, 2018
(86) PCT No.: PCT/AU18/51256

§ 371 Date: May 22, 2020

(30) Foreign Application Priority Data
Nov. 24, 2017 (AU) 2017904752

(51) Int. Cl. A01D 34/00; A01D 34/01; A01D 34/03; A01D 34/412; A01G 7/00; A01D 42/00

(52) U.S. Cl. CPC A01D 34/008; A01D 34/015; A01D 42/00; A01D 34/412; A01G 7/00; A01D 34/03

(57) ABSTRACT

A crop management apparatus for selectively severing plant items from a plurality of plants. The apparatus comprises: a sensor unit for sensing aspects of the plurality of plants and generating data indicative thereof; a control unit for processing the data to determine a location of a target plant item suitable for severing; a cutter unit comprising at least one selectively deployable cutter for severing the target plant item from its respective plant; and a prime mover for moving the sensor unit and the at least one selectively deployable cutter across the plurality of plants. The control unit outputs a control signal to deploy the at least one selectively deployable cutter at least in part based on the determined location of the target plant item. When the at least one selectively deployable cutter is in a deployed state, severance of the target plant item occurs at least in part based on movement of the prime mover.

### FIELD OF THE INVENTION

This invention generally relates to the field of crop management. Certain embodiments relate to a crop management apparatus, a crop management process and a crop harvesting apparatus.

### BACKGROUND OF THE INVENTION

In agriculture and crop cultivation, one aspect of effective crop management involves the harvesting, for example picking, of the target crop. Other aspects include crop plant maintenance such as weed control, pruning, thinning and pollinating.

Certain target crops are selectively and individually harvested, because not all plants are ready to harvest at the same time or they are too delicate or valuable to be collectively harvested. Examples of such target crops include broccoli, asparagus, broccolini, apples, capsicum, zucchini, strawberries and cherries.

Manual labour has been used as a common form of selective harvesting. It is also used for pruning, weeding and other general crop maintenance. In general, field workers traverse a field of crop plants and manually harvest each crop item or, in the case of crop maintenance, manually prune the crop plant or kill/remove the weed.

There are a number of limitation and trade-offs involved with using manual labour for crop management. One limitation is that manual labour can be uneconomical, especially in areas with high labour costs. Another is the exposure of the field worker to a potentially hazardous working environment.

Against a background of these limitations and trade-offs of using manual labour, various crop management apparatus have been developed, which automate or semi-automate an aspect of crop management. For example, various types of harvesting systems include vacuums, shakers and rotary brushes. Automated crop management apparatus often also have limitations and trade-offs, for example between one or more of complexity, reliability, speed, efficiency, scalability and cost.

In light of these and other limitations and trade-offs involved in known crop management methods, there is a need for alternative forms of crop management for use by the agricultural industry.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the present invention there is provided a crop management apparatus for selectively severing plant items from a plurality of plants, the apparatus comprising: a sensor unit for sensing aspects of the plurality of plants and generating data indicative thereof; a control unit for processing the data to determine a location of a target plant item suitable for severing; a cutter unit comprising at least one selectively deployable cutter for severing the target plant item from its respective plant; and a prime mover for moving the sensor unit and the at least one selectively deployable cutter across the plurality of plants, wherein the control unit outputs a control signal to deploy the at least one selectively deployable cutter at least in part based on the determined location of the target plant item; and wherein when the at least one selectively deployable cutter is in a deployed state, severance of the target plant item occurs at least in part based on movement of the prime mover.

In another aspect of the present invention there is provided a crop management process for selectively severing plant items from a plurality of plants, the process comprising the steps of: sensing aspects of the plurality of plants and generating data indicative thereof; processing the generated data to determine a location of a target plant item suitable for severing; deploying a selectively deployable cutter at least in part based on the determined location of the target plant item; and moving the selectively deployable cutter in its deployed state with a prime mover such that severance of the target plant item occurs at least in part based on movement of the prime mover.

In a further aspect of the present invention there is provided a crop harvesting apparatus for selectively harvesting plant items from a plurality of plants, the apparatus comprising: a sensor unit for sensing aspects of the plurality of plants and generating data indicative thereof; a control unit for processing the data to determine a location of a target plant item suitable for harvesting; at least one selectively deployable fluid jet for severing the target plant item from its respective plant; at least one guard element for collecting fluid expended from the at least one selectively deployable fluid jet; and a prime mover for moving the sensor unit, the at least one selectively deployable fluid jet and the at least one guard element across the plurality of plants, wherein the control unit outputs a control signal to deploy the at least one selectively deployable fluid jet at least in part based on the determined location of the target plant item; and wherein when the at least one selectively deployable fluid jet is in a deployed state, severance of the target plant item from its respective plant occurs at least in part based on movement of the prime mover.

In yet another aspect of the present invention there is provided a crop harvesting apparatus for selectively harvesting plant items from a plurality of plants, the apparatus comprising: a sensor unit for sensing aspects of the plurality of plants and generating data indicative thereof; a control unit for processing the data to determine a location of a target plant item suitable for harvesting; a cutter unit comprising a plurality of vertically extending elongate projections arranged such that a predetermined gap is formed between adjacent projections, each projection comprising at least one selectively deployable cutter for severing a target plant item from its respective plant; and a prime mover for moving the sensor unit and the cutter unit across the plurality of plants, wherein the gap between adjacent projections is set such that only a single target plant item can pass between the adjacent projections at any one time; wherein the control unit outputs a control signal to deploy the at least one selectively deployable cutter at least in part based on the determined location of the target plant item; and wherein when the at least one selectively deployable cutter is in a deployed state, severance of a target plant item occurs at least in part based on movement of the prime mover.

In yet a further aspect of the present invention there is provided a crop harvesting apparatus for selectively harvesting plant items from a plurality of plants, the apparatus comprising: a sensor unit for sensing aspects of the plurality of plants and generating data indicative thereof; a control unit for processing the data to determine a location of a target plant item suitable for harvesting; at least one selectively deployable paddle for imparting a force to the target plant item; and a prime mover for moving the sensor unit, the at least one selectively deployable paddle across the plurality of plants, wherein the control unit outputs a control signal to deploy the at least one selectively deployable paddle at least in part based on the determined location of the target plant item; and wherein when the at least one selectively deployable paddle is in a deployed state, the force is imparted to the target plant item at least in part based on movement of the prime mover.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of one embodiment of a crop management apparatus in accordance with the present disclosure;

FIGS. 2A-D are perspective views of a harvesting process carried out on a broccoli crop using the crop management apparatus depicted in FIG. 1;

FIGS. 3A-C depict diagrammatic representations of a target plant item identification process for the broccoli crop of FIGS. 2A-D;

FIGS. 4A-E are plan views depicting the target plant item targeting and harvesting process based on the target plant item identification process of FIGS. 3A-C;

FIGS. 5A-F are perspective views of a harvesting process carried out on a broccoli crop using an alternative embodiment of a crop management apparatus in accordance with the present disclosure;

FIG. 6 is a perspective view of another embodiment of a crop management apparatus in accordance with the present disclosure;

FIG. 7 is a perspective view of a further embodiment of a crop management apparatus in accordance with the present disclosure;

FIGS. 8A-C depict diagrammatic representations of a target plant item identification process for an asparagus crop;

FIGS. 9A-F are plan views depicting the target plant item targeting and harvesting process based on the target plant item identification process of FIGS. 8A-C;

FIG. 10 is a partial perspective view of a further alternative embodiment of a crop management apparatus in accordance with the present disclosure;

FIGS. 11A-D are perspective views of a harvesting process carried out on an asparagus crop using the crop management apparatus depicted in FIG. 10;

FIGS. 12A-C are perspective views of a harvesting process carried out on a trellis tree apple crop using a crop management apparatus in accordance with the present disclosure;

FIGS. 13A-C are perspective views of a harvesting process carried out on a trellis tree apple crop using the crop management apparatus in accordance with the present disclosure;

FIG. 14 shows a block diagram representation of an embodiment of a control system for a crop management apparatus;

FIGS. 15A-C are perspective views of a thinning and pollination process carried out on a trellis tree crop using the crop management apparatus in accordance with the present disclosure.

### DETAILED DESCRIPTION OF THE EMBODIMENTS

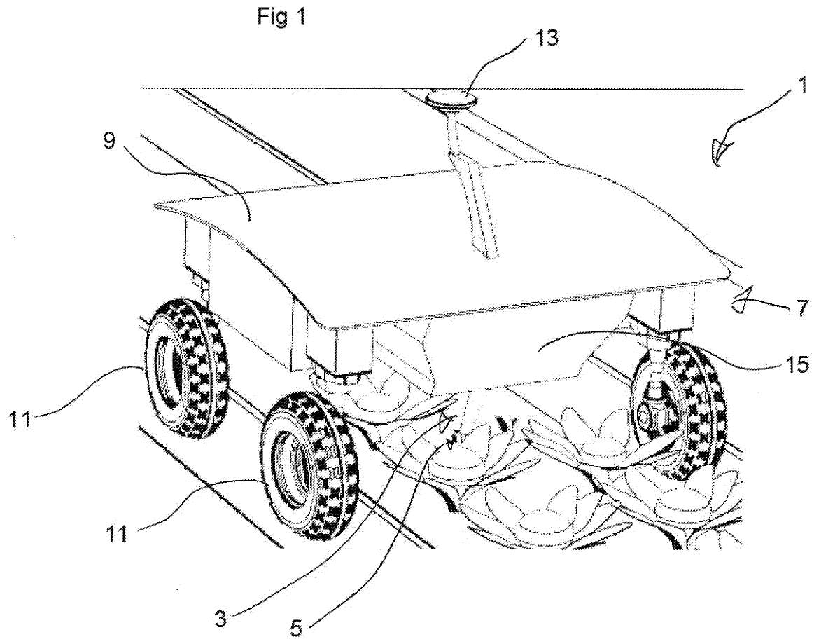

An example crop management apparatus 1 for selectively severing plant items from within a plurality of plants is depicted from a perspective view in FIG. 1. Examples of such plant items include broccoli, asparagus, broccolini, apples, capsicum, zucchini, strawberries and cherries.

The apparatus 1 in this example includes a cutter unit 3 with a selectively deployable cutter 5, and a prime mover 7. In one embodiment the cutter unit 3 includes an elongate projection extending vertically downwards from a body of the prime mover 7 to the selectively deployable cutter 5.

The apparatus 1 includes a sensor unit and a control unit. The sensor unit is capable of sensing one or more of various aspects of a plant item in a sensing area, e.g. plant presence in the sensing area, size, colour, shape, height, volume, planting date, temperature, ripeness and health, and generating data indicative thereof. Accordingly, as will be described in more detail within the following, the sensor unit may include one or more of a variety of different sensors. For example, the sensor unit may include one or more ranging sensors such as LIDAR, acoustic and radar. Alternatively, or in addition, the sensor unit may include one or more imaging sensors such as RGB, infrared, hyperspectral and thermal sensors.

The data generated by the sensor unit is processed by the control unit in accordance with predetermined control logic to determine a location of a target plant item. The control unit is adapted to output a control signal to deploy the selectively deployable cutter 5. The deployment of the selectively deployable cutter 5 is at least in part based on the determined location of the target plant item.

In its deployed state, the selectively deployable cutter 5 of the cutter unit 3 is adapted to cut plant material and is capable of severing a target plant item from its respective plant. As will be described in more detail within the following, in some embodiments this target plant item may be a crop plant item suitable for harvesting. In other embodiments, the target plant item may be extraneous plant material to be pruned from a crop plant, or a weed to be separated from its root stock. In some embodiments the control unit is configurable between two or more modes of operation, with one mode of operation targeting one category or type of plant item and another mode of operation targeting a different category or type of plant item. In some embodiments the sensor unit includes a plurality of sensors. In some embodiments a first subset of the plurality of sensors is utilised for one mode of operation of the control unit and a second subset of the plurality of sensors, different from the first subset, is utilised for another mode of operation of the control unit.

The prime mover 7 is adapted to move the sensor unit and the selectively deployable cutter 5 across the plurality of plants. When the selectively deployable cutter 5 is in a deployed state, severance of a plant item in a target area of the selectively deployable cutter 5 occurs. In some embodiments severance of the plant item in the target area is at least in part based on movement of the prime mover 7.

In some embodiments the sensing area of the sensor and the target area of the selectively deployable cutter 5 are fixed. The controller accordingly is configured to control operation of the selectively deployable cutter 5 based on a displacement of the sensing area and the target area. For example, if the prime mover 7 is moving at a fixed speed, the controller may deploy the selectively deployable cutter 5 a certain time after a target plant item is sensed in the sensing area, or as predicted through an internal model within the control unit. In some embodiments the speed of the prime mover 7 is variable, either due to its own operation or due to being towed or otherwise moved by another device that can operate at various speeds. In these embodiments the controller may be additionally configured to control deployment of the selectively deployable cutter 5 based on a determined speed of travel of the prime mover 7. The speed of travel or the position of the prime mover 7 may be determined by a suitable speed or position sensor, for example based on one or more of a global positioning system (GPS) signal, a wheel speed sensor (odometry), a speedometer and a LIDAR based speed sensor or as generated through a collection of imaging and ranging sensors.

In the embodiment depicted in FIG. 1, the prime mover 7 is an autonomous Unmanned Ground Vehicle (UGV) with a chassis 9 supported on wheels 11 and an antenna 13. The antenna 13 may be configured to receive and/or transmit optical or radio signals to a base station and/or configured to receive GPS signals or corrections. One or more of the wheels 11 may be driving wheels, driven by generally known means, such as individual, direct-drive electric motors, an electric motor, an internal combustion engine, etc. It will be appreciated that, in alternative embodiments, the prime mover 7 may be a manually controlled vehicle, such as a motorised tractor and in other embodiments a drawn trailer, for carriage by hand or by another motorised device, for example a tractor.

In one embodiment the selectively deployable cutter 5 operates with a component that is substantially transverse to the direction of travel of the prime mover 7. In one embodiment the selectively deployable cutter 5 operates at between 45 degrees and 135 degrees (inclusive) to the direction of travel of the prime mover. In one embodiment the selectively deployable cutter 5 operates at approximately 90 degrees to the direction of travel of the prime mover. In one embodiment the angle of operation of the selectively deployable cutter 5 is fixed. In other embodiments the angle of operation of the selectively deployable cutter 5 and/or the position of operation of the selectively deployable cutter 5 is variable, for example under control of the control unit based on information from the sensor unit. The cutter unit 3 may accordingly also comprise one or more actuators for controlling the orientation and/or position of the cutter 5 relative to the prime mover 7.

In one embodiment the cutting action of the selectively deployable cutter 5 is implemented as a fluid jet. For example, the selectively deployable cutter 5 is provided with left and right side-facing outlets, which in one embodiment are provided at or near the lower extremity of the cutter unit 3. It will be appreciated that other forms of cutters, such as lasers, telescopic knives, hot wires and reciprocating knives, may be utilised in addition, or as an alternative, to the fluid jet.

In one embodiment the prime mover 7 includes a collection unit 15, adapted to collect target plant items severed from their respective plants. It will be appreciated that the collection unit 15 may be omitted from the apparatus 1 in situations where collection of the severed target plant items is not required, e.g. is either unnecessary or carried out by alternative means. In one embodiment, the collection unit 15 includes a constantly deployed collector that, when deployed, is capable of collecting severed target plant items and leaving non-severed plant items in place. More specifically, the constantly deployed collector of the collection unit 15 utilises a vacuum to suck severed target plant items. The collection unit 15 further includes a hopper (not shown) to store the harvested plant items collected by the collection means.

It will be appreciated that, in alternative embodiments, other collection means may also be utilised by a constantly deployed collector, such as low strength grippers, brushes, gravity, etc. It will also be appreciated that the collection unit may include a selectively deployable collector in addition, or alternatively, to the constantly deployed collector. The deployment of such a selectively deployable collector can be activated by a control signal output from the control unit.

The apparatus 1 depicted in FIG. 1 incorporates the sensor unit, control unit, cutter unit 3, prime mover 7 and collection unit 15 within a single UGV. It will be appreciated that other configurations are possible in which the sensor unit, control unit, cutter unit and/or collection unit are provided in separate vehicles. The separate vehicles may be driven or towed by a prime mover, which may or may not carry one or more of the sensor unit, control unit, cutter unit and collection unit. Alternatively, the control unit may be located at the base station, receiving data from the sensor unit and sending control signals to the cutter unit, for example via radio or other communication means.

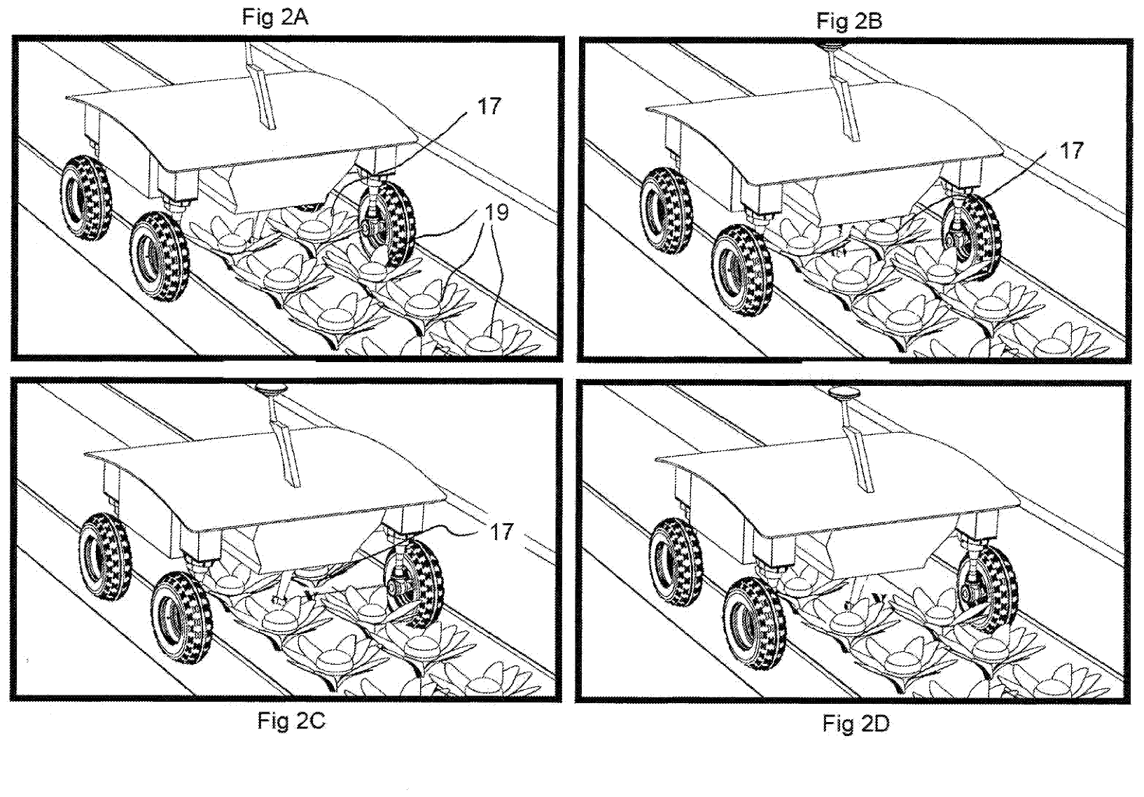

Turning to FIGS. 2A-4E, an embodiment of a harvesting process will now be described in which the crop management apparatus 1 depicted in FIG. 1 selectively severs and harvests a target broccoli head 17 from a plurality of broccoli plants 19.

As shown in FIG. 2A, the prime mover 7 of the crop management apparatus 1 traverses the plurality of broccoli plants 19. The broccoli plants 19 are detected by the sensor unit working in combination with the control unit, with aspects such as detected location, size, volume or other parameters such as health, ripeness stored by the control unit, for example by a mapping of one or more characteristics detectable by the sensor unit to the relevant plant parameter(s). In some embodiments, data fusion and machine learning techniques are used to model and classify the targets of interest in the environment.

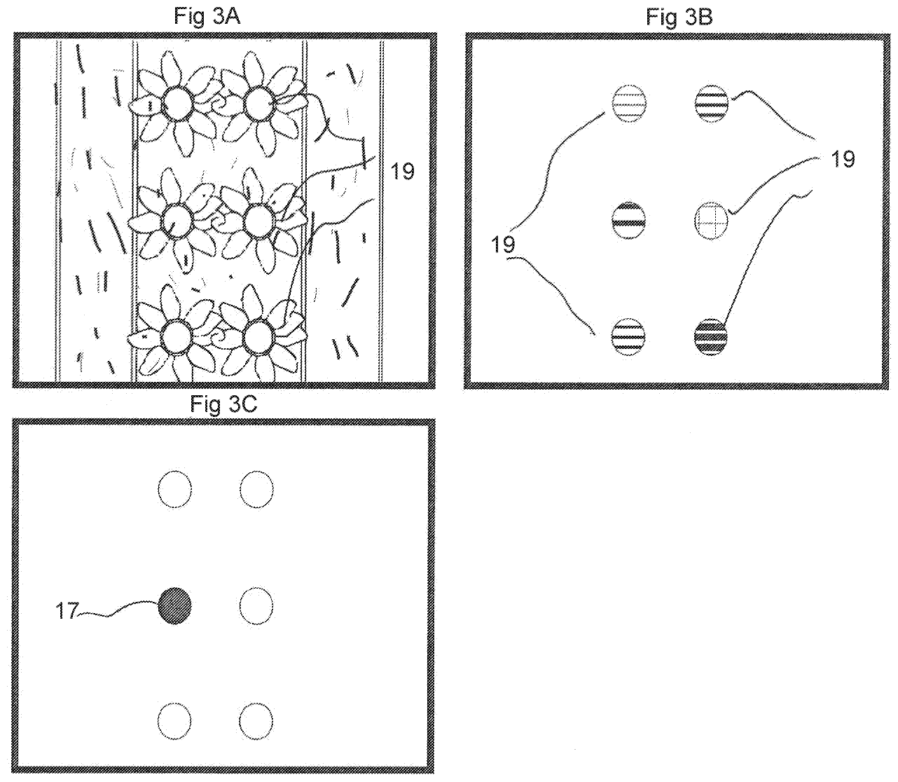

FIG. 3A depicts a diagrammatic representation of example raw sensor data, gathered by the sensor unit while the prime mover 7 is traversing the plants 19. In this example the raw data is a video or photograph of the ground over which the prime mover 7 is traversing or is about to traverse. The control unit partially processes this raw sensor data to identify broccoli head locations as depicted by the diagrammatic representation of FIG. 3B. This data is subsequently further processed by the control unit to identify the target broccoli head 17 for harvesting, as depicted by the black circle in the diagrammatic representation of FIG. 3C.

The decision for determining which broccoli heads are ready to be selectively harvested can be based on one or a combination of parameters, including for example: head size, colour, shape, height, volume, planting date, temperature, and health. The broccoli heads selected for harvesting can be input into a continuous planning system within the control unit, and the control unit then controls the selectively deployable cutter 5 to sever each broccoli head in succession.

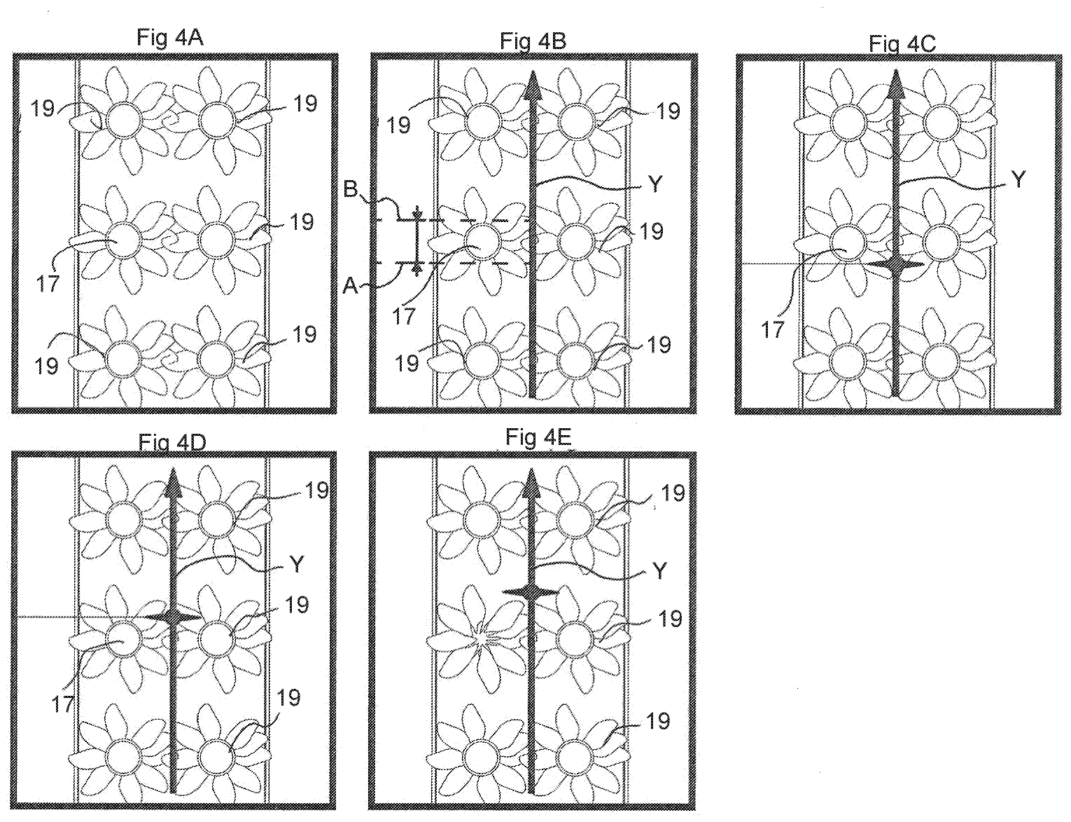

In some embodiments, raw sensor data is filtered or cleaned prior to completion of a plant identification step. For example, FIG. 4A is a filtered and cleaned version of FIG. 3A. In other embodiments, at least the plant identification step is performed based on the raw sensor data.

As shown in FIG. 4B, once the target broccoli head 17 for harvesting has been identified, the continuous planning system within the control unit determines a start point A and an end point B for deploying the left side of selectively deployable cutter 5 while the prime mover is traversing the plurality of broccoli plants 19 in direction Y. Accordingly, as shown in FIGS. 2B and 4C, the control unit causes deployment of the left side of selectively deployable cutter 5 once start point A is reached. The prime mover 7 propels the cutter unit 3 to end point B while the left side of selectively deployable cutter 5 is continuously deployed, see FIG. 4D, such that the target broccoli head 17 is severed from its respective broccoli plant. The severed broccoli head 17 is collected by the collection unit 15 (see FIG. 2C). At end point B the deployment of the left side of the selectively deployable cutter 5 is caused to be ceased by the control unit. In one embodiment the prime mover 7 keeps moving throughout the process and continues moving past end point B.

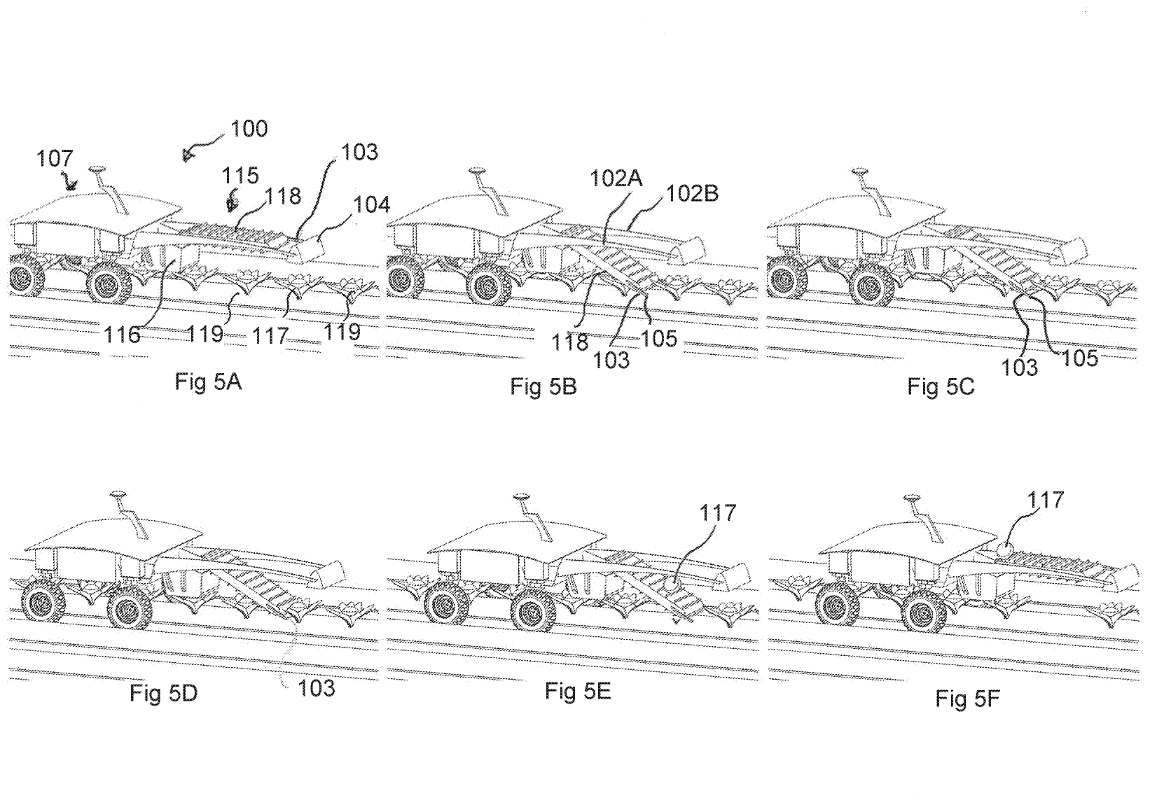

FIGS. 5A-F depict a harvesting process carried out by an alternative crop management apparatus 100, to selectively severe and harvest a target broccoli head from a plurality of broccoli plants 119. Crop management apparatus 100 is similar to crop management apparatus 1 described above, apart from the location of the sensor units and cutter units, and the collection means utilised by the collection unit. As such, like reference numerals are used for like parts.

The prime mover 7 of crop management apparatus 100 is provided with two substantially parallel, cantilevered arms 102A, 102B that extend substantially horizontally from chassis 9. Sensor unit 104 of crop management apparatus 100 is provided between the arms 102A, 102B, in the embodiment shown at a distal end thereof from the prime mover 7.

Collection unit 115 includes an open hopper 116 and a selectively deployable conveyor belt collector 118. The open hopper 116 is provided so as to span below the ends of arms 102A, 102B proximal the prime mover 7. The conveyor belt collector 118 is selectively pivotable between a non-deployed state as depicted in FIG. 5A and a deployed state as depicted in FIGS. 5B-E. In the non-deployed state, the conveyor belt collector 118 travels over the plants and therefore leaves the plants undisturbed.

Cutter unit 103 is formed as an elongate projection extending longitudinally from a right side of the end of conveyor belt collector 118 distal from open hopper 116. The selectively deployable cutter 105 provides a fluid jet through a left side outlet at the distal extremity of cutter unit 103.

In some embodiments the sensor unit 104 and control unit combine to control the height of the fluid jet expelled by the cutter 105 by controlling the angle of the conveyor belt collector 118. In some embodiments the sensor unit 104 and control unit determines a height of the ground at the location of the cutter unit 103 and controls the angle of the conveyor belt collector 118 to ensure the cutter unit 103 clears the ground or for example to cut the target item at the ideal position which may save further processing in the production system.

The process for identifying a target broccoli head 117 for harvesting with crop management apparatus 100 is similar to the process described above with respect to crop management apparatus 1, and thus will not be repeated. The actual harvesting process is also similar, but with a number of minor variations described below.

Once the target broccoli head 117 has been identified, the continuous planning system calculates not only the cutter start and end points for deploying the selectively deployable cutter 105, but also the collection start and end points for deploying the conveyor belt collector 118 while the prime mover is traversing the plurality of broccoli plants 119. In one embodiment at least one of the collection start and end points are different from the cutter start and end points. For example, the collection start point may precede the cutter start point by a predetermined distance or time. In one embodiment the predetermined distance or time allows the collection unit 115 to stabilise in position prior to the deployment of the cutter.

Accordingly, as shown in FIG. 5B, the control unit deploys the conveyor belt collector 118 before deploying the cutter 105. The cutter 105 is then deployed (see FIG. 5C) and the prime mover 7 propels the cutter unit 103 to the cutter end point while the selectively deployable cutter 105 is continuously deployed (see FIGS. 5C-D), such that the target broccoli head 117 is severed from its respective broccoli plant. The cutter 105 is deactivated (see FIG. 5E) and the severed broccoli head 117 is transported up the conveyor belt collector 118 as depicted in FIGS. 5E and 5F. When the collection end point is reached, the conveyor belt collector 118 is pivoted back to its non-deployed state shown in FIG. 5F. In some cases, where the continuous planning system deems it appropriate, the cutter unit 103 and/or the collector may remain continuously deployed throughout the harvesting of consecutive target items.

Whilst the crop management apparatus 100 depicted in FIGS. 5A-F has been described with reference to the use of the selectively deployable conveyor belt collector 118, it will be appreciated that other forms of selectively deployable collection means may also be utilised. For example, the conveyor belt collector 118 may be replaced by a selectively pivotable catcher mechanism that, in the non-deployed state, extends from the open hopper 116 at an angle above horizontal such that any collected target item rolls or falls into the open hopper 116.

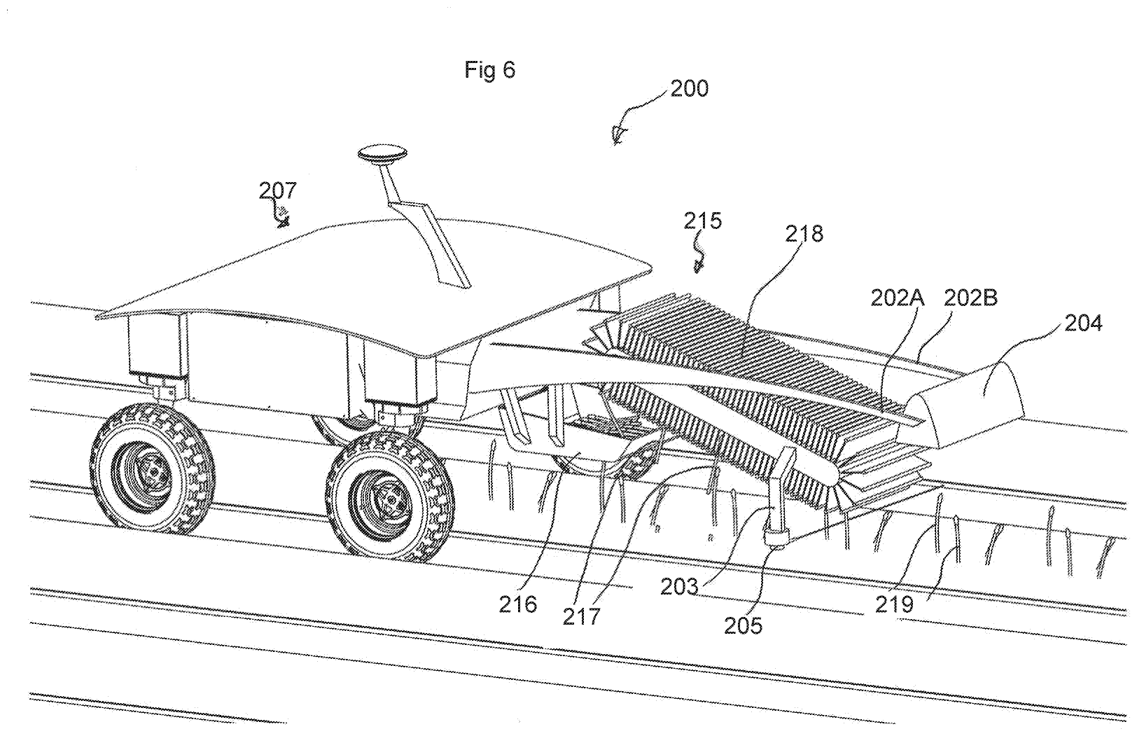

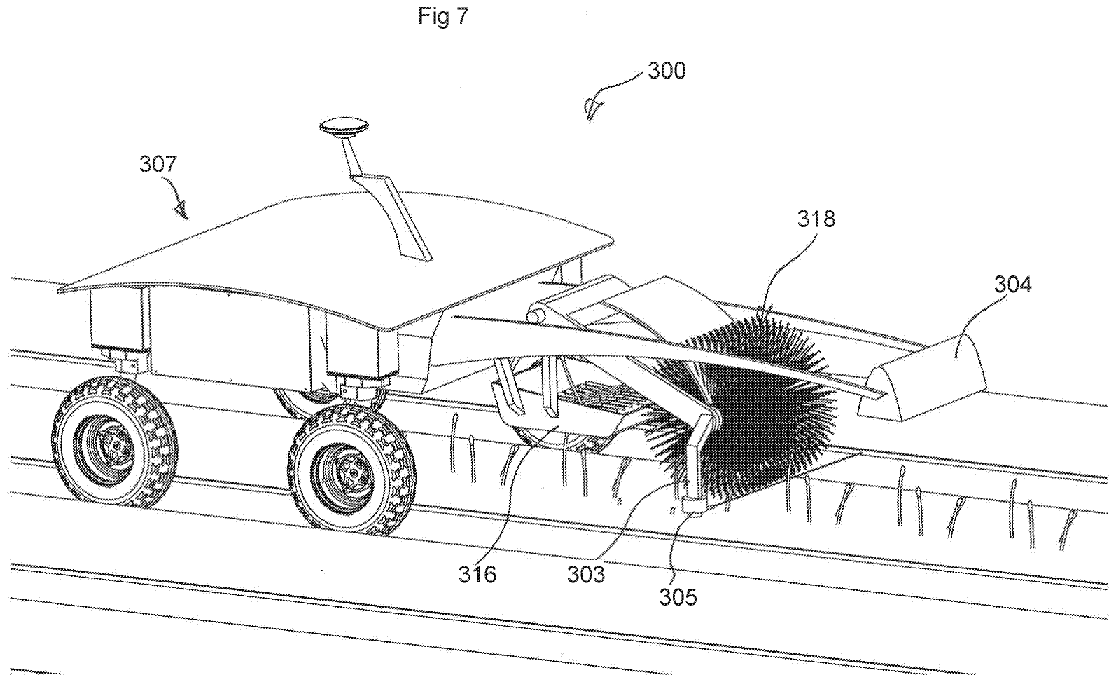

Also, whilst the harvesting process utilising crop management apparatus 100 as depicted in FIGS. 5A-F has been described with reference to the harvesting of broccoli heads from a plurality of broccoli plants, it will be appreciated that crops other than broccoli may be harvested using the same or a similar collector. For example, crop management apparatus 200 and crop management apparatus 300 depicted in FIGS. 6 and 7, respectively, are similar to crop management apparatus 100 and may be suitable for the harvesting of asparagus crops.

FIG. 6 shows a further alternative crop management apparatus 200. Crop management apparatus 200 is similar to crop management apparatus 1 described above, apart from the location of the sensor units and cutter units, and the collection means utilised by the collection unit. As such, like reference numerals are used for like parts.

As shown in FIG. 6, collection unit 215 of crop management apparatus 200 includes an open hopper 216 and a conveyor collector 218 with soft and flexible clamping grippers 218A. The open hopper 216 is provided in a similar manner to that of open hopper 116, although it is slung lower from the arms 202A, 202B to allow for the severed asparagus spears 217 to be supplied from the underside of the conveyor collector 218.

In one embodiment the conveyor collector 218 is pivotable between a non-deployed state (not shown) and a deployed state as depicted in FIG. 6. In the non-deployed state the conveyor collector 218 extends between the arms 202A, 202B so as to travel above the crop.

In another embodiment the conveyor collector 218 is continuously deployed. The soft and flexible clamping grippers 218A are strong enough to hold the severed asparagus spears 217 and prevent them from falling, but not so strong as to damage the non-severed asparagus spears 219 that remain in the ground.

Cutter unit 203 is formed as an elongate projection extending downwards from a right side of the end of conveyor collector 218 distal from open hopper 216. The selectively deployable cutter 205 is formed as a fluid jet provided with a left side outlet at the distal extremity of cutter unit 203.

The crop management apparatus 200 is configured so that the collector operates simultaneously on a plant item with the cutter. For example, the conveyor collector 218 is configured to hold the plant items when they are adjacent to the cutter unit 203. While the plant items are held, the cutter unit 203 selectively either severs or does not sever the plant item from its respective plant. For the plant items that are severed, the conveyor collector 218 carries the plant item away from the plant to the hopper 216. For the plant items that are not severed, the plant pulls the plant item out from the conveyor collector 218 as the crop management apparatus 200 moves past the plant.

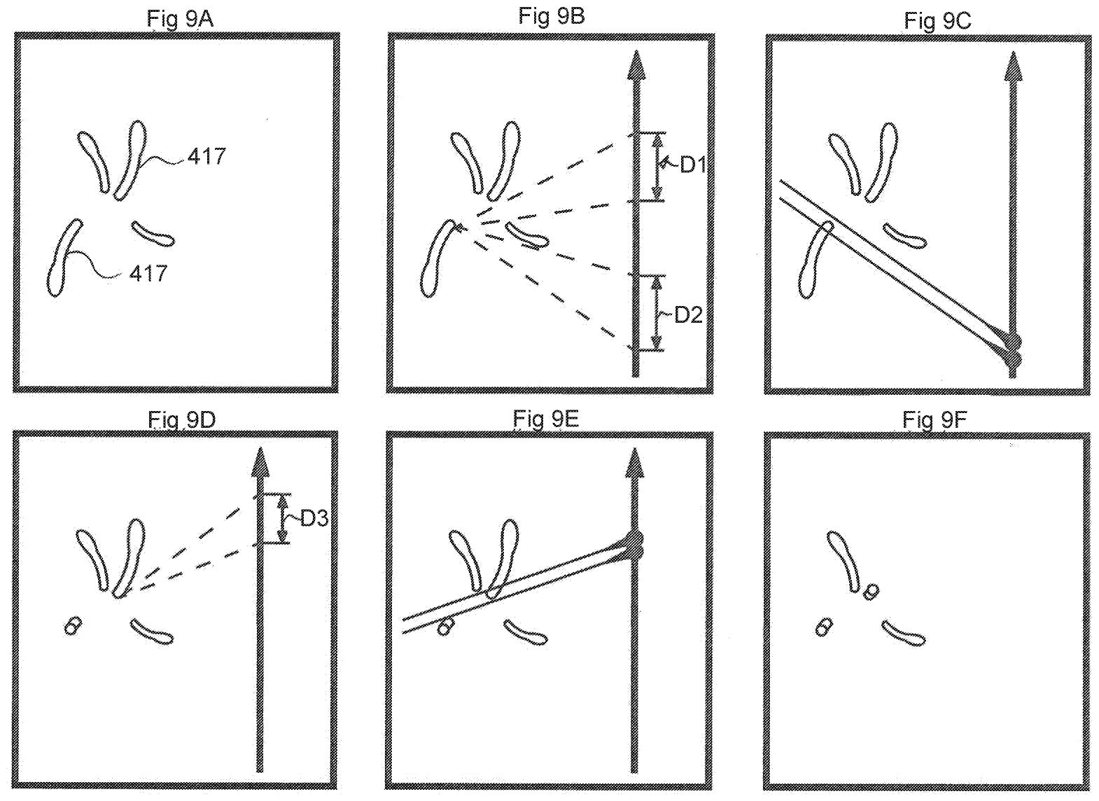

As discussed above, in its deployed state, the conveyor collector 218 is capable of collecting the severed asparagus spears 217 and leaving non-severed asparagus spears 219 in place. As such, there is no need to pivot the conveyor collector 218 between a deployed and non-deployed state. Nevertheless, the sensor unit 204 and control unit (not shown) can combine to control the height of the fluid jet expelled by the cutter 205 by controlling the angle of the conveyor collector 218 or by rotating the jet to adjust its angle of elevation using a separate motor system. Furthermore, in some embodiments, the cutter can be rotated to adjust its angle of orientation forwards/backwards if the application requires, e.g. as shown in FIG. 9.

Crop management apparatus 300 depicted in FIG. 7 is substantially similar to crop management apparatus 200 of FIG. 6, apart from the collection unit 315. Specifically, whereas collection unit 215 of crop management apparatus 200 includes the conveyor collector 218 with soft and flexible clamping grippers 218A, collection unit includes a rotating brush collector 318 with soft and flexible bristles 318A.

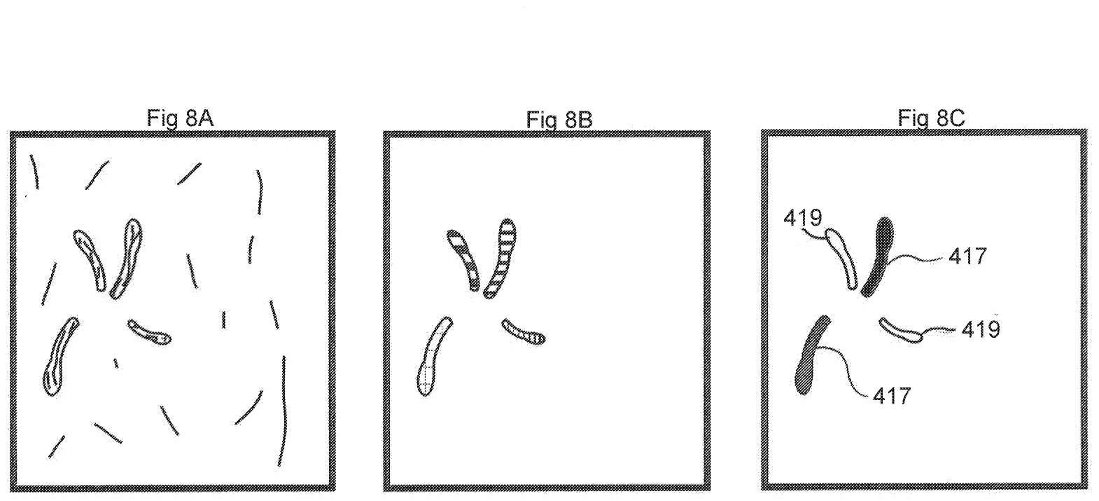

Turning to FIGS. 8A-9F, a harvesting process will now be described, for example for implementation by a crop management apparatus as described herein. The process is described with reference to harvesting asparagus spears 417 from a plurality of asparagus plants 419, although it will be appreciated that the process may also be utilised for other plants.

A prime mover traverses the plurality of asparagus plants 419 while the asparagus plants 19 are tracked by a sensor unit in combination with a control unit, with aspects such as detected location, size, volume or other parameters such as health, ripeness stored by the control unit. FIG. 8A depicts a diagrammatic representation of the raw sensor data gathered by the sensor unit while the prime mover is traversing the plants 419. The control unit partially processes this raw sensor data to identify asparagus spear locations, as depicted by the diagrammatic representation of FIG. 8B. This data is subsequently further processed by the control unit to identify the target asparagus spears 417 for harvesting as depicted by the solid black asparagus silhouettes in the diagrammatic representation of FIG. 8C.

As was the case for broccoli harvesting, the decision for determining which asparagus spears are ready to be selectively harvested can be based on one or a combination of variables, including: colour, height, planting date, temperature, ripeness or health. The asparagus spears selected for harvesting are then input into a continuous planning system within the control unit, and the control unit then controls the selectively deployable cutter(s) to sever each target asparagus spear 417.

FIG. 9A represents a result of the process shown in FIG. 8, with two target asparagus spears 417 identified and two non-target asparagus spears 419 also identified. As shown in FIGS. 9B and 9D, once the target asparagus spears 417 for harvesting have been identified, the continuous planning system within the control unit determines valid regions D1, D2, D3 within which the cutter can be enabled. These regions D1, D2, D3 may be determined based on one or more predetermined constraints, for example maximum angle and range constraints of the cutter. The regions may also or instead be determined based on the identification of obstacles that need to be avoided by the cutter.

The planning system determines at least one of an orientation angle and start and end points within regions D1, D2, D3, for deploying the cutter while the prime mover is traversing the plurality of asparagus plants 419 in direction Y. Accordingly, as shown in FIGS. 9C and 9E, the control unit deploys the cutter once the respective start point is reached, the prime mover propels the cutter unit to the respective end point while the fluid jet cutter is continuously deployed such that the target asparagus spear is severed its respective asparagus plant. The deployment of the cutter is ceased, the cutter orientation adjusted, if needed, and the cutter deployed again within the next deployment region. The severed asparagus spears 417 are collected by collector and the prime mover keeps travelling. While FIG. 9 depicts individual deployment of the cutter for each target asparagus spear, it will be appreciated that the planning system may determine that a plurality of target asparagus spears can be severed with a single deployment. In some cases the system only partially cuts or perforates the item so that it remains in position for collection, yet has been weakened so that it can be collected without excessive force.

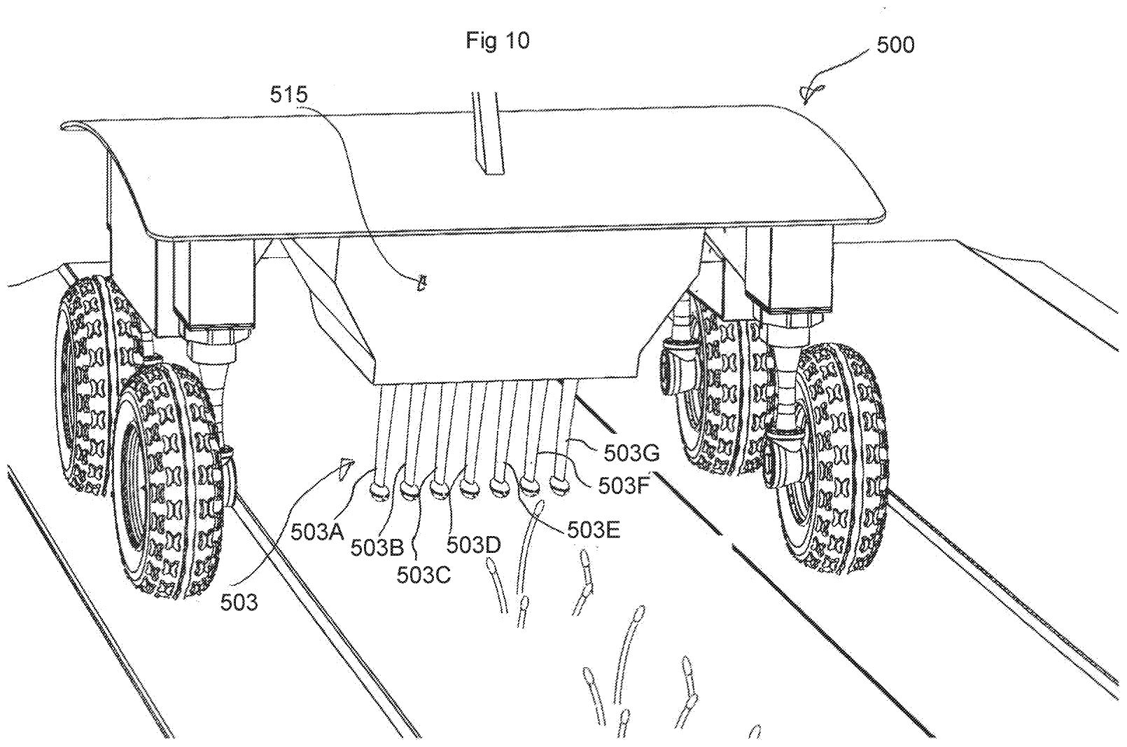

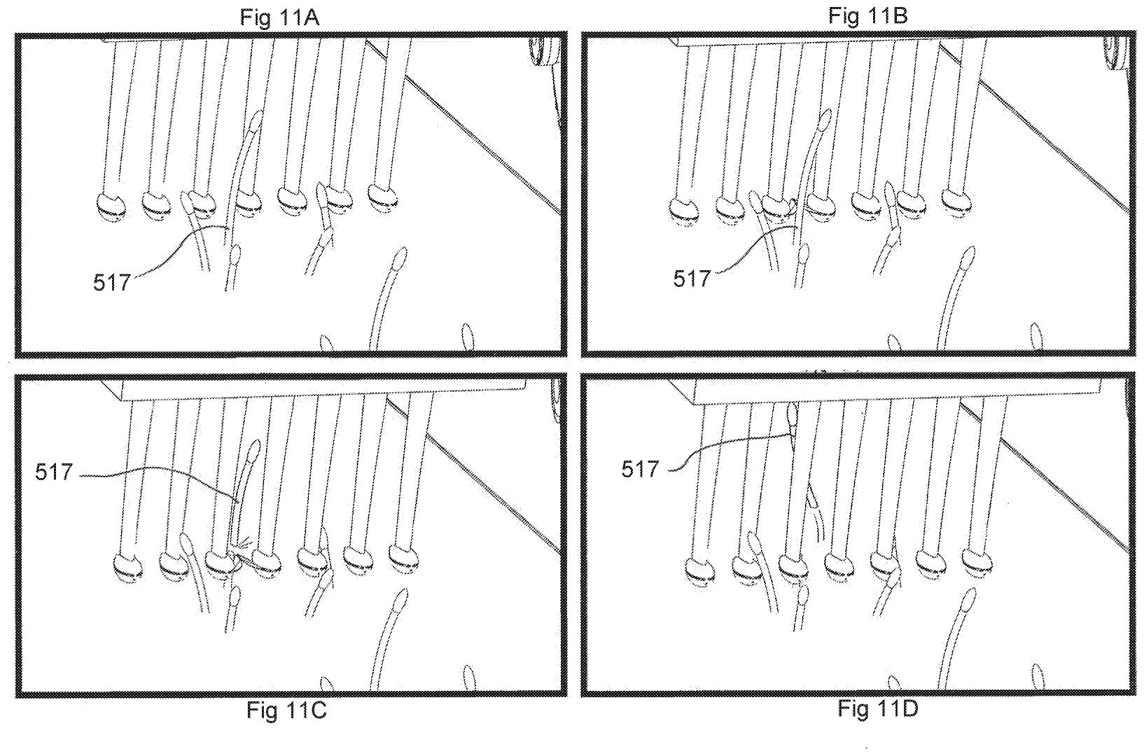

Another crop management apparatus 500 suitable for the harvesting of asparagus crops is depicted in FIGS. 10 and 11A-D. Crop management apparatus is substantially similar to crop management apparatus 1, with a cutter unit 503 configured to harvest asparagus rather than broccoli. Cutter unit 503 includes a plurality of elongate projections 503A-G that extend vertically downwards, in this example from the collection unit 515, and which are arranged across a harvest area, in this example in a row substantially perpendicular to the direction of travel of the prime mover 507.

Each projection 503A-G is provided at its lower extremity with a selectively deployable cutter 505A-G. The cutters 505A, 505G of the furthest left and right projections 503A, 503G include single rotating knives (not shown) that, in their deployed state, extend towards adjacent cutters 505B, 505F, respectively, to span approximately half the gap. As exemplified in FIGS. 11B and 110, the remaining cutters 505B-F each include a left rotating knife and a right rotating knife that, in their deployed state, extend towards adjacent cutters to span approximately half the gap. It will be appreciated that, in some embodiments, each full gap may be spanned by a single cutter rather than a pair of cutters, such that only a single cutter is present in each gap.

At the time for which the continuous planning system of the control unit has identified the location of an asparagus spear 517 suitable for harvesting should begin, the control unit outputs a control signal to deploy the left and right rotating knives of adjacent cutters to span the gap through which the target asparagus spear 517 will pass, as depicted in FIG. 11B. The prime mover 507 continues to propel the cutter unit 503, and the deployed left and right rotating knives sever the target asparagus spear 517 from the remainder of the asparagus plant based on the motion of the prime mover 507, as depicted in FIG. 11C. The severed asparagus spear 517 is then collected, for example by a vacuum collection unit 515 and the left and right rotating knives are deactivated as shown in FIG. 11D. The cutters are then retracted after a pre-determined distance, time or as determined by the continuous planning system.

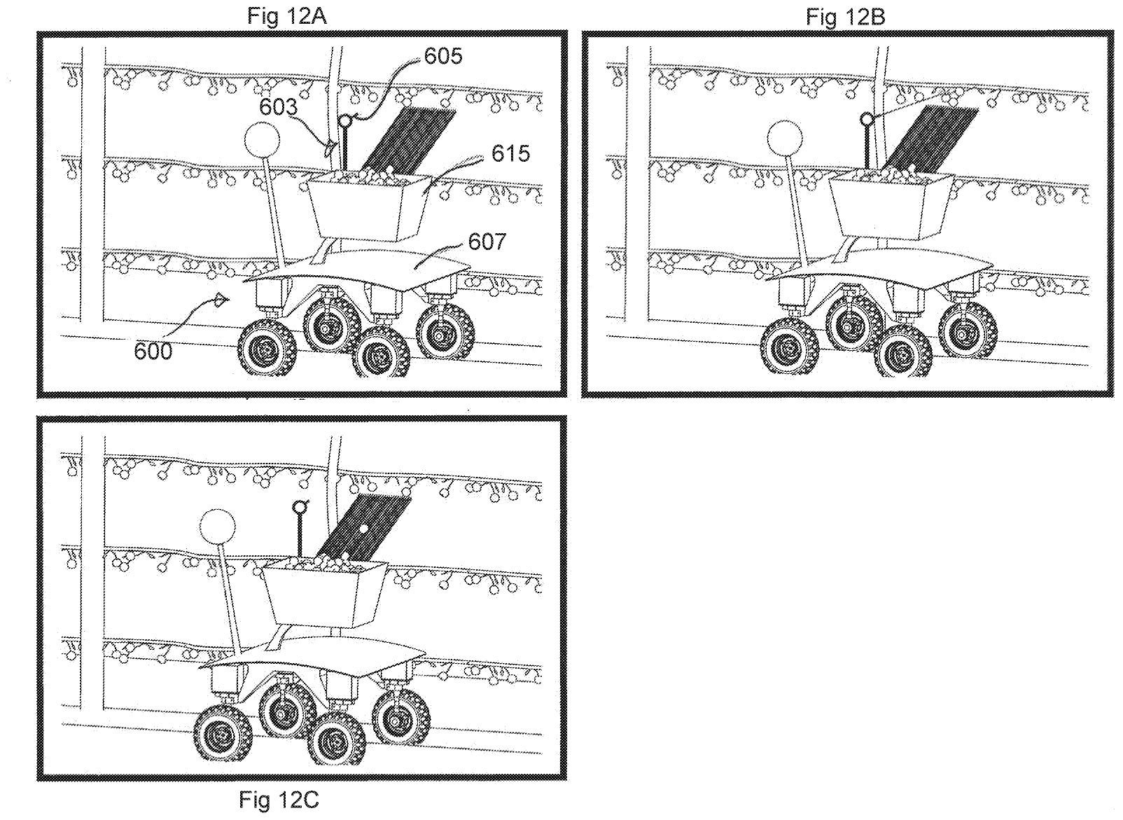

Another crop management apparatus 600 suitable for the harvesting of trellis tree apple crops is depicted in FIGS. 12A-C. Similar to crop management apparatus 1, the apparatus in this example includes a sensor unit, a control unit, a cutter unit 603 with a selectively deployable cutter 605, and a prime mover 607. The prime mover 607 shares the same basic configuration of the prime movers described above, having a chassis 9 supported on wheels 11 and an antenna 13, and thus it will be appreciated that a prime mover may be configured for use within both a crop management apparatus suitable for row crops and a crop management apparatus suitable for trellis tree crops.

In this example, the cutter unit 603 is formed as an elongate projection extending upwards from a collection unit 615 mounted to the chassis 609 of the prime mover 607. The selectively deployable cutter 605 is formed as a fluid jet, and the cutter unit 603 includes one or more actuators for controlling angles of elevation and/or orientation of the fluid jet outlet relative to the prime mover 7.

The collection unit 615 is adapted to collect apples severed from their respective trellis trees, and includes an open hopper 616 and a ramp collector 618 with soft brushes for directing severed apples to the open hopper 616.

Once the continuous planning system of the control unit has identified the location of an apple 617 suitable for harvesting, it can then determine the necessary elevation and orientation angles to which the fluid jet outlet needs to be actuated and the required start and end points for deploying the fluid jet cutter 605 while the prime mover 607 is traversing the crop to sever the target apple 617 from the trellis tree. Accordingly, as shown in FIGS. 12B and 12C, the control unit deploys the fluid jet cutter 605 once the respective start point is reached, and the prime mover 607 propels the cutter unit 603 to the respective end point while the fluid jet cutter 605 is continuously deployed such that the target apple 617 is severed from the trellis tree. The severed apple 617 is caught by the passive ramp collector 618 and directed into the hopper 616, while the fluid jet cutter 605 is deactivated and the prime mover 607 continues travelling, as depicted in FIG. 12C.

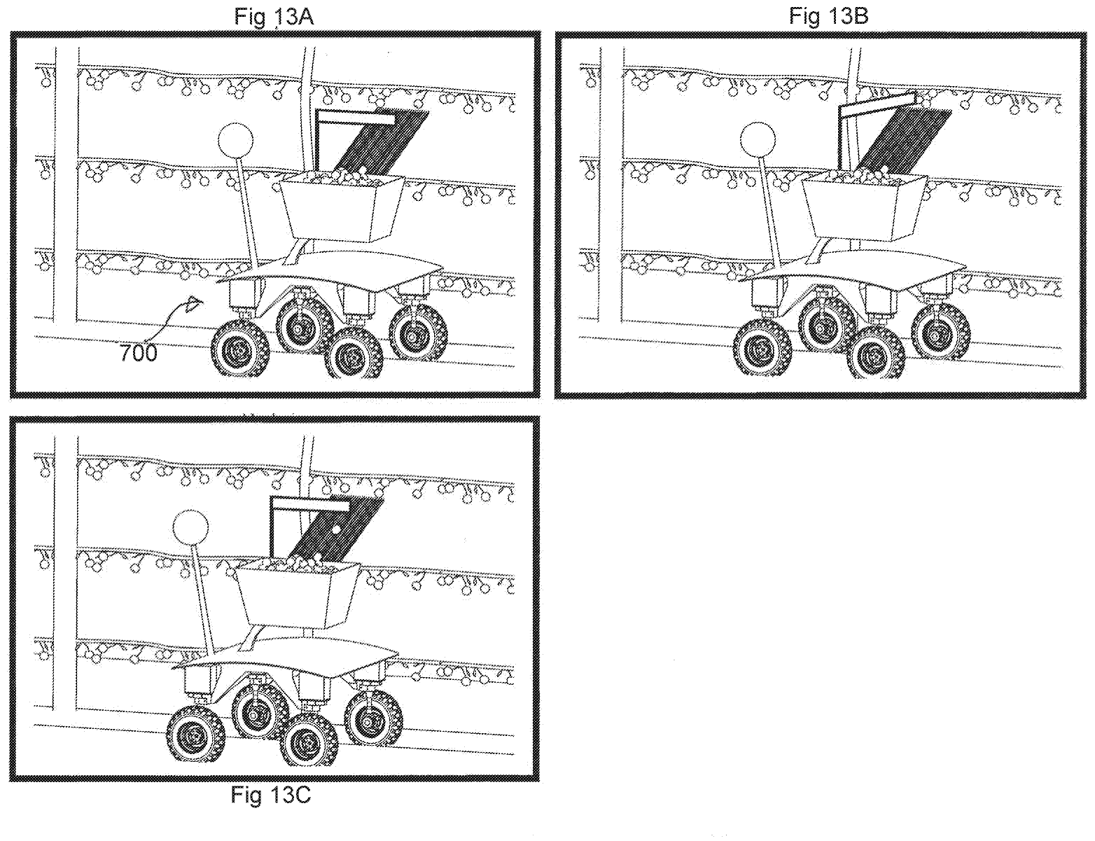

FIGS. 13A-C depict another crop management apparatus 700 also suitable for the harvesting of trellis tree apple crops. The apparatus 700 in this example is substantially similar to the crop management apparatus 600 described immediately above, apart from the use of a harvest unit 703 with a selectively deployable paddle 705 in place of a cutter unit. The harvest unit 703 is formed as an elongate projection extending upwards from the collection unit 715 with the selectively deployable paddle 705 attached at the upper end of the projection. The harvest unit 703 includes one or more actuators for controlling the height and/or angular displacement of selectively deployable paddle 705.

Once the continuous planning system of the control unit has identified the location of an apple 717 suitable for harvesting, it can then determine the necessary height and angular displacement to which paddle 705 needs to be actuated and the required start and end points for deploying the paddle 705 while the prime mover 707 is traversing the crop to impart a force to the target apple 717 and thereby detach it from the trellis tree. Accordingly, as shown in FIGS. 13B and 13C, the control unit deploys the paddle 705 once the respective start point is reached, and the prime mover 707 propels the harvest unit 703 to the respective end point while the paddle 705 is continuously deployed such that the target apple 717 is detached from the trellis tree. The detached apple 717 is caught by the passive ramp collector 718 and directed into the hopper 716, while the paddle 705 is deactivated and the prime mover 707 continues travelling, as depicted in FIG. 13C.

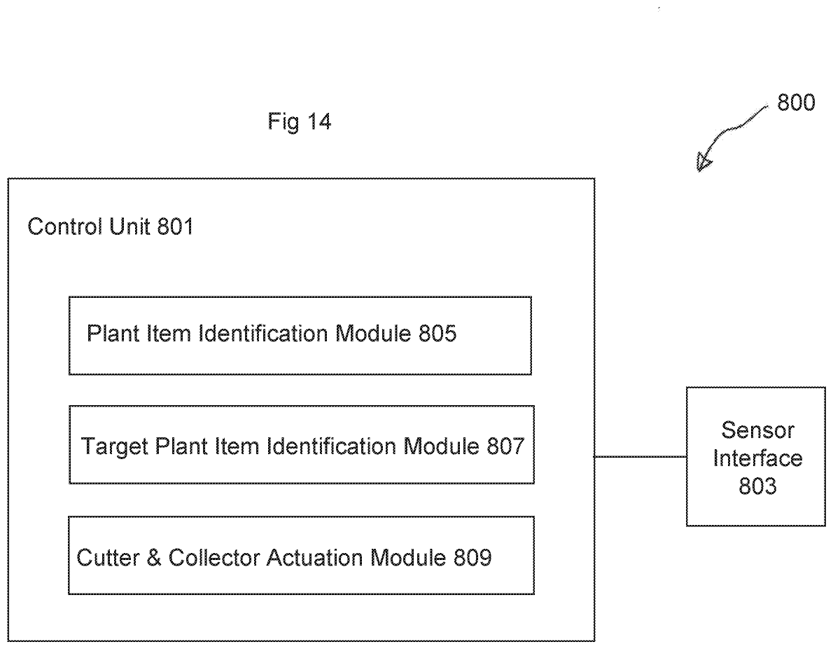

FIG. 14 shows a block diagram representation of an embodiment of a control system 800 for a crop management apparatus, for example a crop management apparatus as described herein. The control system 800 includes a control unit 801, which includes a number of modules. The modules comprise software, firmware and/or hardware for implementing certain functionality, as described herein. The term module is therefore used to depict functional modules, without necessarily requiring modular construction. The control unit 801 may include one or more microprocessors, microcontrollers, integrated circuit chips and other circuitry configured, by software, firmware and/or hardware for its purpose described herein.

The control system 800 includes a sensor interface 803 for receiving information, for example photographic or video data from a sensor. The modules of the control unit include a plant item identification module 805 for processing sensor data and identifying candidate plant items for harvesting, a target plant item identification module 807 for determining, based on one or more characteristics of the sensor data which of the candidate plant items to harvest and which not to harvest, a planning module 809 for determining operation of the cutter and collector in order to harvest the plant items identified by the target plant item identification module 807 and a cutter and collector actuation module 809 for sending control signals to the cutter and/or collector.

A power system is provided for the crop management apparatus. The power system provides the energy to selectively deploy the cutter and collector. The power system may comprise one more engines or batteries.

It will be appreciated that, in some embodiments of the present disclosure, the sensor unit has a known geometric transformation to the cutter/harvesting unit that is either fixed or known through sensing. By providing the continuous planning system with such a known geometric transformation, accurate deployment of the cutter/harvesting unit can be made. The plurality of plants and target plant items are tracked accurately through time by the sensor unit and the control unit so that accurate interaction occurs with the cutter/harvesting unit and with the collection unit.

As previously mentioned, the sensor units of some embodiments may include one or more feedback sensors. These feedback sensors may be formed by any of the ranging or imaging sensors described above, and may be provided at the rear of the apparatus system so as to be able to detect the success rate or accuracy and precision of the cutting/harvesting operation.

Data from feedback sensors may be useful for providing an operator with an indication that there is a malfunction in the cutter/harvesting unit and that maintenance is required. For example, a low harvest success rate may indicate that a cutter blade is broken/blunt or that there is a blockage/deviation in the supply line or jet stream of fluid jet cutter. Alternatively, or in addition, the sensor unit may further include one or more sensors provided in the cutter/harvesting unit itself to detect such a malfunction.

For example, in some embodiments, a fluid jet cutter may be provided with a flow rate sensor to detect blockages in the supply line or jet stream. In other embodiments, a torque sensor may be provided for detecting the force being applied to the target item by the cutter/harvesting unit. For example, in the case of a cutter/harvesting unit using a knife blade, excessive force may indicate that the blade needs replacing or resharpening, and the converse may indicate that the blade is broken and needs replacing.

In some embodiments that use a collection unit, the sensor unit may further include level sensor or weigh scale provided at the collection unit hopper to detect how full the hopper is. When the control unit determines that the hopper is full based on the data from the level sensor or weigh scale, an operation is preferably carried out to empty or replace the hopper. For example, the crop management apparatus may drive a centralised location at which it can transfer the harvested target plant items by emptying or transferring the hopper, or it may call for another vehicle to come and collect the harvested target plant items in the same manner. In these embodiments, the hopper is either autonomously swappable, tippable or has a drain hatch to transfer the contents.

The control unit may also be configured to actively determine the class or grade of target plant items during the harvest process. These determinations may be based on aspects of the target plant items sensed by the sensor unit, such as quality, size, colour etc. In these embodiments, multiple collection hoppers may be provided and the collection unit may be configured to actively segregate the harvested plant items and direct particular plant items to particular collection hoppers based on the determined class or grade.

The sensor unit may further include sensors to detect the presence, location and type of foreign bodies within or around the harvested targeted plant items, e.g. spiders, mice, sticks, rocks, rubbish etc. In some embodiments, the collection unit may include a filter means configured to remove leaves or other foreign bodies from the harvest plant items.

As discussed above, the crop management apparatus may include one or more actuators to vary the orientation and/or position of the deployed cutting/harvesting means utilised by the cutter/harvesting unit. It will be appreciated that, in some embodiments, other characteristics of the deployed cutting/harvesting means may be variable, and may be actively adjusted or respond dynamically according to sensed characteristics and feedback or as dictated by a particular application. Examples of such additional or alternative adjustable or dynamic characteristics include:
the pressure, flow rate, abrasivity and temperature used, for example, by fluid jet cutters;
the frequency, power and polarisation used, for example, by laser cutters;
the holding force, torque, reciprocation amplitude/velocity, angle of attack and range used, for example, by knife cutters, brushes, paddles and wipers;
the angular velocity, torque and angle of attack used, for example, by spinning cutters; and
the temperature, current, power or voltage and tension used, for example, by hot wire cutters.

It will be appreciated that the characteristics set out in the non-exhaustive list above are not exclusive to their respective cutter/harvester. For example, in embodiments in which a knife or spinning cutter is used as the cutting/harvesting means, the blade of the respective cutter may also be variably heated to assist in the cutting operation and/or reduce cross contamination between target plant items.

In embodiments where the cutting/harvesting means utilised by the cutter/harvesting unit is a fluid jet cutter, the crop management apparatus may further include a guard element to protect equipment from damage or to recycle and collect expended fluid. Such a guard element may be fixed relative to the nozzle of the fluid jet cutter, the collection unit or elsewhere on the system structure.

In embodiments where a cutter blade is used, the cutter/harvesting unit may further include a mechanism for self-sharpening and cleaning. In some embodiments, the self-sharpening and cleaning operation may be carried out during the deployment and deactivation processes of the cutter blade, such as during the extension and retraction of a linearly extensible cutter blade.

In the depicted embodiments, the cutter/harvesting unit and the collection unit have been described as generally operating discretely and independently of each other, i.e. it is the cutter/harvesting unit that severs or detaches the target plant item from its respective plant, and it is the collection unit that collects the severed/detached target plant item. It will be appreciated that, in other embodiments, the operation of the cutter/harvesting and collection unit may overlap or combine in a synergetic manner.

For example, in some embodiments, the collection means may assist the cutter/harvesting unit with severing or detaching the target plant item from its respective plant by imparting an additional disruptive or supportive force. The crop management apparatus may further comprise means to direct a supply of fluid such as air or water generally in the cutting region so that severed or detached target plant items are blown or forced towards the collection unit, while the remaining plant items are sufficiently undamaged by any direct or indirect flow due to this fluid.

In some embodiments, the cutter/harvesting unit may further include a catcher adapted to restrict, catch or guide the motion of the severed or detached target plant item. For example, a rotationally deployable knife blade may be provided with a catcher that, when the knife blade is retracted to the disengaged position, moves a severed target plant item into a region where the collection unit means is able to collect the item.

The collection unit described above with respect to FIG. 5 includes a single, selectively deployable conveyor belt collector that extends from the chassis of the prime mover along a generally central axis thereof, and has a lateral dimension that extends perpendicular to the vertical direction, e.g. the drive axes of the conveyor belt extend in the horizontal direction. It will be appreciated that some embodiments may utilise one or more conveyor belt collectors that are offset from the central axis of the prime mover.

It will also be appreciated that some embodiments may utilise two vertically spaced conveyor belt collectors for holding and transporting target plant items that are clamped between the two belts. These vertically positioned conveyor belt collector may hold target plant items in position while they are being cut and then pick up the cut target plant item to transport it to the collector hopper. In such embodiments, the clamping force between the two vertically spaced conveyor belts must be low enough to not damage plant items that have not been cut, but strong enough to lift and transport the cut target plant items. To assist in facilitating such a holding and transporting method, the conveyor belt collectors may incorporate brushes, soft materials, paddles etc.

In embodiments in which the crop management apparatus is configured to harvest overhead crops, such as kiwi fruit, or angled crops, such as on a trellis tree as described with respect to FIGS. 12A-130, the collection unit utilises gravity to assist in the collection of cut or detached target plant items. In such embodiments the collection areas which lead the cut or detached target plant items to roll down into the collection hopper, such as the ramp collectors depicted in FIGS. 12A-13C, may be provided with shock absorbing installations, such as cushions, nets, brushes, etc. The collection hopper and/or ramp/pad collectors may be adjustable in height or angle in order to minimise the fall distance, impact forces or retrieval speed of the cut target plant items. In some embodiments, ramp/pad collectors may be omitted and the collection unit may be configured to allow no pad is used and the cut target plant items fall directly into the collection hopper. In some embodiments, the position of the hopper itself is controlled in order to for instance minimise the distance an item needs to free-fall, reducing the impact forces and preventing or minimising damage to the plant.

As described above, the collection unit may be omitted in situations where the crop management apparatus is used for cutting/detaching only and collection is either unnecessary or carried out by alternative means. For example, in pruning, thinning or weeding processes, the cut target plant item may be left amongst the plurality of plants to rot and compost, or may be collected by other means. Alternatively, in harvesting situations in which target plant items are produce crops, cut target plant items may be left either in situ (e.g. as through a partial cut) or to fall to a stable position for later collection by another vehicle.

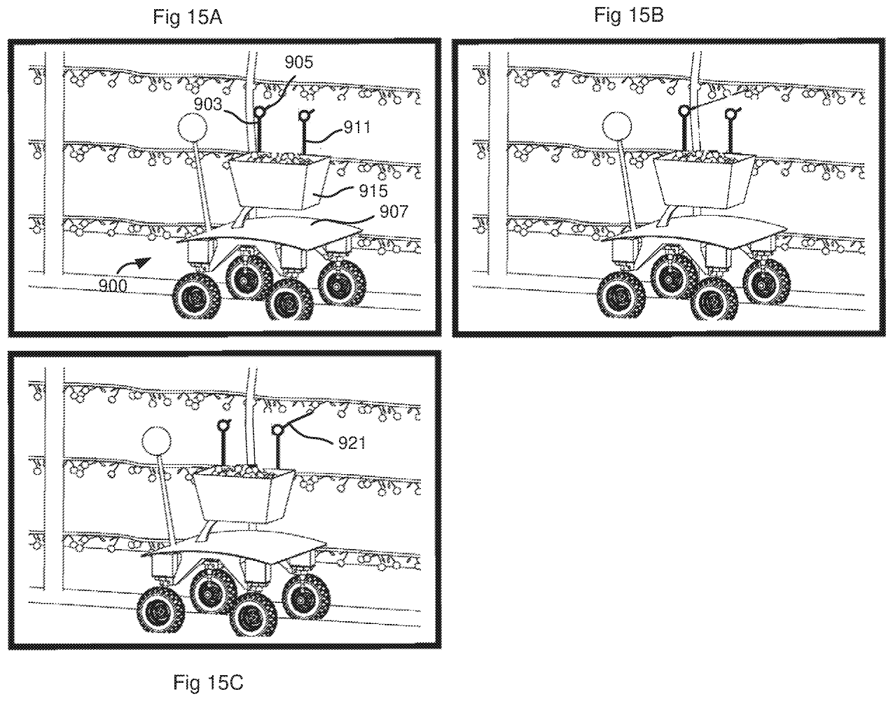

One particular situation where collection is unnecessary and a cut target plant item may be left amongst the plurality of plants to rot and compost is during selective bloom thinning and pollination. A crop management apparatus 900 suitable for selectively thinning and pollinating blooms of trellis tree crops, such as tomatoes, eggplants, peppers and legumes, is depicted in FIGS. 15A-C. The apparatus 900 in this example is substantially similar to the crop management apparatus 600 described above, and includes a sensor unit, a control unit, a thinning unit 903, a pollinating unit 911, a pollen storage unit and a prime mover 907.

In this example, the thinning unit 903 and the pollinating unit 911 are formed as elongate projections extending upwards from a collection unit 915 mounted to the chassis 909 of the prime mover 907. By mounting the thinning unit 903 and the pollinating unit 911 to the collection unit 915, it may be possible to reduce the number of modifications necessary to transform or alter a crop management apparatus suitable for harvesting, e.g. crop management apparatus 600, into a crop management apparatus 900 suitable for thinning and pollinating. The collection unit 915 may also serve as a convenient location to stow the pollen storage unit. It will be appreciated that, in other embodiments, the collection unit may be omitted and the thinning unit 903 and the pollinating unit 911 may be mounted directly to the prime mover 907, or via other physical features such as the pollen storage unit.

In this example, the thinning unit 903 includes a selectively deployable cutter 905 formed as a high-pressure fluid jet for cutting blooms from the trellis tree, and one or more actuators for controlling angles of elevation and/or orientation of the fluid jet outlet relative to the prime mover 907. It will be appreciated that, in other embodiments, the thinning unit 903 may include alternative means for thinning, such as a selectively deployable disrupter formed as a fluid jet for knocking blooms off the trellis tree, a selectively deployable paddle similar to that discussed above in relation to crop management apparatus 700, and selectively deployable brushes and wipers.

In this example, the pollinating unit 911 includes a selectively deployable pollen applicator 921 formed as a fluid jet for blowing pollen, and one or more actuators for controlling angles of elevation and/or orientation of the fluid jet outlet relative to the prime mover 907. In some embodiments, the intake for the fluid jet may be formed in the pollen storage unit such that the pollen may be mixed with the fluid supplied to the fluid jet. In other embodiments, the intake for the fluid jet may be formed separate from the pollen storage unit, and the pollen may be mixed with the fluid blown from the outlet of the low-pressure fluid jet. For example, the pollen may be injected into the fluid blown from the outlet, or sucked out of a supply conduit by the fluid blown from the outlet using the venturi effect. It will be appreciated that, in other embodiments, the selectively deployable pollen applicator 921 may take alternative forms, such as selectively deployable paddles, brushes and wipers that may be coated with pollen supplied from 720 the pollen storage unit.

The continuous planning system of the control unit identifies the locations of blooms suitable for thinning and blooms suitable for pollinating. It can then determine the necessary elevation and orientation angles to which the outlet of the fluid jet cutter 905 needs to be actuated and the required start and end points for deploying the fluid jet cutter 905 while the prime mover 907 is traversing the crop to sever a thinning target bloom from the trellis tree. It can then also determine the necessary elevation and orientation angles to which the outlet of the fluid jet applicator 921 needs to be actuated and the required deployment point for the fluid jet applicator 921 to selectively pollinate a pollinating target bloom.

Accordingly, as shown in FIG. 15B, the control unit deploys the fluid jet cutter 905 once the respective start point is reached, and the prime mover 907 propels the cutter unit 903 to the respective end point while the fluid jet cutter 905 is continuously deployed such that the thinning target bloom is severed from the trellis tree. The fluid jet cutter 605 is deactivated, as depicted in FIG. 15C, and the fluid jet applicator 921 is deployed to selectively pollinate the pollinating target bloom.

In the described example, the pollinating target bloom is pollinated directly following the severance of the thinning target bloom. It will be appreciated that alternative thinning and pollination sequences are envisaged and may include situations where pollination first occurs after the severance of two or more thinning target blooms, and/or the pollen applicator is deployed to sequentially pollinate two or more pollinating target blooms.

It will be understood that the invention disclosed and defined in this specification extends to all alternative combinations of two or more of the individual features mentioned or evident from the text or drawings. All of these different combinations constitute various alternative aspects of the invention.

1. A crop management apparatus for selectively severing plant items from a plurality of plants, the apparatus comprising:
a sensor unit for sensing aspects of the plurality of plants and generating data indicative thereof;
a control unit for processing the data to determine a location of a target plant item suitable for severing;
a cutter unit comprising at least one selectively deployable cutter for severing the target plant item from its respective plant; and
a prime mover for moving the sensor unit and the at least one selectively deployable cutter across the plurality of plants,
wherein the control unit outputs a control signal to deploy the at least one selectively deployable cutter at least in part based on the determined location of the target plant item; and
wherein the prime mover and cutter unit are configured so that when the at least one selectively deployable cutter is in a deployed state, the cutter unit clears ground over which the prime mover is moving and severance of the target plant item occurs at least in part based on movement of the prime mover.

2. The crop management apparatus of claim 1, wherein the sensor unit comprises at least one ranging sensor.

3. (canceled)

4. The crop management apparatus of claim 1, wherein sensor unit comprises at least one imaging sensor.

5. (canceled)

6. The crop management apparatus of claim 1, wherein the aspects of the plurality of plants sensed by the sensor unit include as least one of the following variables: size, colour, shape, height, volume, planting date, temperature and health.

7. The crop management apparatus of claim 1, wherein the sensor unit comprises at least one feedback sensor for sensing whether severance of the target plant item was successful.

8. The crop management apparatus of claim 1, wherein the cutter unit further comprises at least one actuator for controlling the orientation and/or position of the at least one cutter relative to the prime mover.

9. The crop management apparatus of claim 1, wherein the at least one cutter is deployed in a linearly extensible manner.

10. The crop management apparatus of claim 9, wherein the at least one cutter is one of a fluid jet, a laser, a telescopic knife, a hot wire and a reciprocating knife.

11. The crop management apparatus of claim 1, wherein the at least one cutter is deployed in a rotationally extensible manner.

12. The crop management apparatus of claim 9, wherein the at least one cutter is rotating knife.

13. The crop management apparatus of claim 1 further comprising:
a pollinating unit having at least one selectively deployable pollen applicator for applying pollen to a target plant bloom;
a pollen storage unit.

14. The crop management apparatus of claim 13, wherein the at least one selectively deployable pollen applicator is a fluid jet, and the pollinating unit further comprises at least one actuator for controlling the orientation and/or position of the fluid jet relative to the prime mover.

15. The crop management apparatus of claim 1 further comprising a collection unit for collecting severed target plant items.

16. The crop management apparatus of claim 15, wherein the collection unit comprises at least one selectively deployable collector, and wherein the control unit outputs a control signal to deploy the at least one selectively deployable collector to selectively collect the severed target plant item at least in part based on the determined location of the target plant item.

17. The crop management apparatus of claim 15, wherein the collection unit comprises a passive collector configured such that, in its deployed configuration, the passive collector is capable of collecting severed target plant items and leaving non-severed plant items substantially undisturbed.

18. The crop management apparatus of claim 15, wherein the passive collector utilises one of the following collection means: a vacuum, low strength grippers, brushes and gravity.

19. The crop management apparatus of claim 17 or 18, wherein the collection means utilised by the passive collector imparts additional force to the target plant items to assist in severing the target plant items from their respective plants.

20. (canceled)

21. (canceled)

22. (canceled)

23. (canceled)

24. (canceled)

25. A crop harvesting apparatus for selectively harvesting plant items from a plurality of plants, the apparatus comprising:
a sensor unit for sensing aspects of the plurality of plants and generating data indicative thereof;
a control unit for processing the data to determine a location of a target plant item suitable for harvesting;
at least one selectively deployable fluid jet for severing the target plant item from its respective plant;
at least one guard element for collecting fluid expended from the at least one selectively deployable fluid jet; and
a prime mover for moving the sensor unit, the at least one selectively deployable fluid jet and the at least one guard element across the plurality of plants,
wherein the control unit outputs a control signal to deploy the at least one selectively deployable fluid jet at least in part based on the determined location of the target plant item; and
wherein when the at least one selectively deployable fluid jet is in a deployed state, severance of the target plant item from its respective plant occurs at least in part based on movement of the prime mover.

26. The crop management apparatus of claim 25, wherein the guard element is fixed relative to a nozzle of the fluid jet.

27. A crop harvesting apparatus for selectively harvesting plant items from a plurality of plants, the apparatus comprising:
a sensor unit for sensing aspects of the plurality of plants and generating data indicative thereof;
a control unit for processing the data to determine a location of a target plant item suitable for harvesting;
a cutter unit comprising a plurality of vertically extending elongate projections arranged such that a predetermined gap is formed between adjacent projections, each projection comprising at least one selectively deployable cutter for severing a target plant item from its respective plant; and
a prime mover for moving the sensor unit and the cutter unit across the plurality of plants,
wherein the gap between adjacent projections is set such that only a single target plant item can pass between the adjacent projections at any one time:
wherein the control unit outputs a control signal to deploy the at least one selectively deployable cutter at least in part based on the determined location of the target plant item; and
wherein when the at least one selectively deployable cutter is in a deployed state, severance of a target plant item occurs at least in part based on movement of the prime mover.

28. (canceled)
